(19) United States
(12) Patent Application Publication
(10) Pub. No.: US 2006/0043028 A1
(43) Pub. Date: Mar. 2, 2006

(54) Process for in-site cleaning of drinking water filtration media

(76) Inventors: Ulrich Reimann-Philipp, Norman, OK (US); Wolfgang Zwanziger, Oklahoma City, OK (US); Jeffrey Schulhoff, Oklahoma City, OK (US)

Correspondence Address: BORDEN LADNER GERVAIS LLP, 1100-100 QUEEN ST, OTTAWA, ON, K1P 1J9, CA

(21) Appl. No.: 10/926,272

(22) Filed: Aug. 24, 2004

(51) Int. Cl. B01D 24/46

(52) U.S. Cl. 210/793; 210/792; 210/796; 210/275

(57) ABSTRACT

The present invention provides a process to clean said water filtration media in a filtration bed. The process includes applying a granular cleaner to the water filtration media and applying a catalyst to the water filtration media. This causes a chemical reaction between the granular cleaner, catalyst and water filtration media resulting in the cleaning of the water filtration media. The residue granular cleaner and catalyst, along with suspended and dissolved contamination from the water filtration media, are rinsed by the application of water.

### REFERENCE TO PENDING APPLICATIONS

This application is not based upon any pending domestic or international patent applications.

### REFERENCE TO MICROFICHE APPENDIX

This application is not referenced in any microfiche appendix.

### FIELD OF THE INVENTION

The present invention is generally directed toward a cleaning process. More specifically, the present invention is directed toward a process for cleaning granular water filter media, such as sand, anthracite coal or activated carbon.

### BACKGROUND OF THE INVENTION

Filtration is an essential step in the treatment of drinking and industrial water supplies. Filtration is carried out to remove contaminants which are either introduced with the source water or are produced during the treatment process and which can affect water quality. Most commonly large-scale filtration involves passing the water either through granular filter media, such as sand anthracite coal or granular activated carbon.

Contaminants removed during filtration accumulate in the top layer of granular filter media beds. Over time, this accumulation leads to increased filter backpressure (measured by increased head loss), increased turbidity of the flow-through or breakthrough of contaminants. Regular removal of the filtrate through backwashing is necessary in order to maintain filter performance and capacity.

Like every surface in contact with water, filter media particles will over time accumulate deposits of biological and non-biological origin. Depending on the water source and environmental conditions, these deposits can consist predominantly of organic matter (biofilm), metal oxides, or calcium carbonate scale. Heavy fouling or scaling will eventually reduce filter performance. The consequences can be higher backwash frequency, reduced flow-rates, increased water turbidity, breakthrough of contaminants or a combination of these effects. Filter media exchange becomes necessary when filter performance declines beyond tolerable levels.

Both mechanical and chemical means of filter bed cleaning are currently available. Mechanical methods include filter bed aeration during backwash and spraying water on top of the filter bed to disperse soft aggregates. Chemical treatments include washing the media in strong acids and bases, sometimes in combination with surfactants. These treatments can be satisfactory for certain types of contamination, such as calcium carbonate scale. However, mixed deposits, which include metal oxides and biological films, are either not removed efficiently or require highly corrosive and hazardous cleaning agents. This generates a need for alternative cleaning procedures, which are sufficiently efficient and convenient to present an alternative to media replacement.

### BRIEF SUMMARY OF THE INVENTION

The present invention satisfies the need discussed above. The present invention is generally directed toward a cleaning process. More specifically, the present invention is directed toward a process for cleaning granular water filter media, such as sand, anthracite coal or activated carbon.

In one aspect, the present invention provides a process to clean water filtration media contained within a filtration bed. The process comprises applying a granular cleaner and a catalyst to the water filtration media while the media is located within the filtration bed. The granular cleaner reacts in conjunction with the catalyst resulting in the cleaning of the media. After the cleaning has occurred, the residue granular cleaner and catalyst are washed away along with the suspended and dissolved contamination which was removed from the water filtration media.

In the process above, the granular cleaner can be selected from the following composition:

| Component | Volume Range |
|---|---|
| sulfamic acid; | 50-99% |
| citric acid; | 0-10% |
| phosphoric acid; | 0-10% |
| corrosion inhibitor; | 0-10% |
| free-flow additive; | 0-10% |
| surfactant; and | 0-10% |
| sodium bicarbonate | Balance |

In the process above, the composition for the granular cleaner set out above can have hydrochloric acid to replace phosphoric acid in the same range of volume.

In the process above, the catalyst can be selected from either 5-75% hydrogen peroxide, or 0.2-10% peracetic acid with the balance being water.

In the above process, the catalyst can be in a liquid or dry state prior to its introduction into the filtration bed.

In the above process, the washing away of the residue granular clean and suspended and dissolved contamination can be conducted through a backwashing procedure.

In the above process, the chemical reaction between the granular cleaner and catalyst proceeds for at least 1 hour prior washing away of the residue granular clean and suspended and dissolved contamination.

Further objects and features of the present invention will be apparent to those skilled in the art upon reference to the accompanying drawings and upon reading the following description of the preferred embodiments.

### BRIEF DESCRIPTION OF THE DRAWINGS

FIG. 1 is a schematic of an embodiment 10 of the present invention.

FIG. 2 is a schematic of an additional embodiment 100 of the present invention.

FIG. 3 is a schematic of an additional embodiment 110 of the present invention.

### DETAILED DESCRIPTION OF THE PREFERRED EMBODIMENTS

Before explaining the present invention in detail, it is to be understood that the invention is not limited to the preferred embodiments contained herein. The invention is capable of other embodiments and of being practiced or carried out in a variety of ways. It is to be understood that the phraseology and terminology employed herein are for the purpose of description and not of limitation.

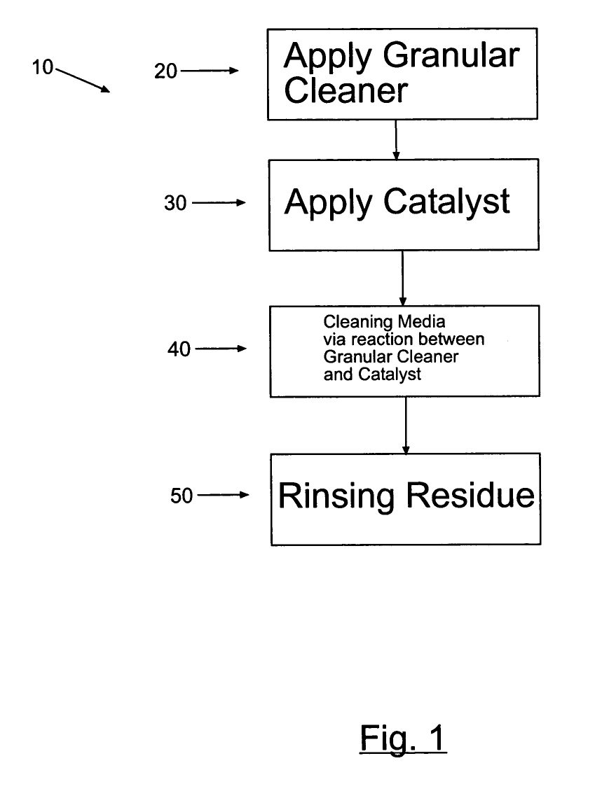

As shown in FIG. 1, an embodiment of the process to clean water filtration media contained within a filtration bed 10 of the present invention is disclosed. This embodiment describes a process to clean water filtration media comprising applying a granular cleaner 20 and a catalyst 30 to the water filtration media while the media is located within the filtration bed. The granular cleaner chemically reacts in conjunction with the catalyst resulting in the cleaning of the media 40. After the cleaning has occurred, the residue granular cleaner and catalyst are washed away along with the suspended and dissolved contamination which was removed from the water filtration media 50.

An embodiment of the present invention includes a granular cleaner selected from the following composition:

| Component | Volume Range |
|---|---|
| sulfamic acid; | 50-99% |
| citric acid; | 0-10% |
| phosphoric acid; | 0-10% |
| corrosion inhibitor; | 0-10% |
| free-flow additive; | 0-10% |
| surfactant; and | 0-10% |
| sodium bicarbonate | Balance |

An additional embodiment of the granular cleaner includes the composition set out above with the phosphoric acid being replaced with hydrochloric acid in the same range of volume.

Yet, an additional embodiment of the present invention, the catalyst can be selected from either hydrogen peroxide or peracetic acid. Further embodiments of the catalyst include hydrogen peroxide in a volume range of 5-75% or peracetic acid in a volume range of 0.2-10% with the balance being water. Additionally, the catalyst can be in a liquid or dry state prior to its introduction into the filtration bed.

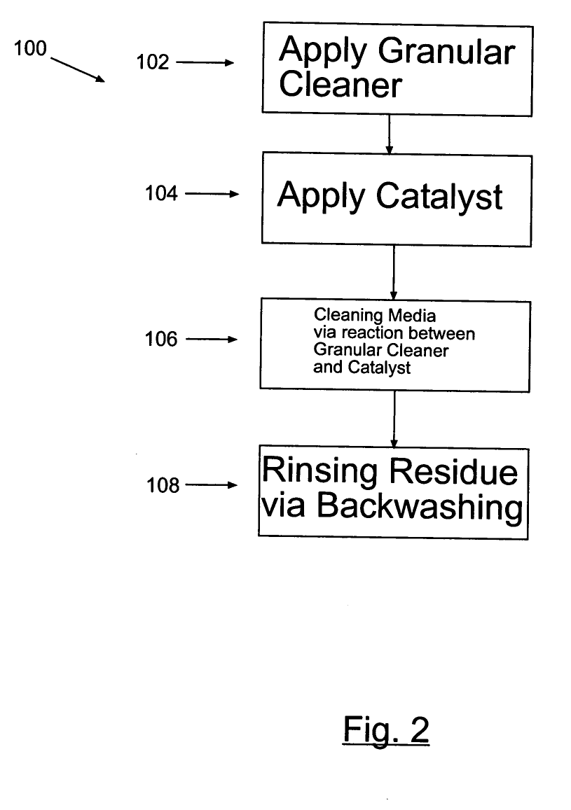

As shown in FIG. 2, an additional embodiment 100 of the present invention includes the step of the washing away of the residue cleaning chemicals and suspended and dissolved contamination can be conducted through a backwashing procedure.

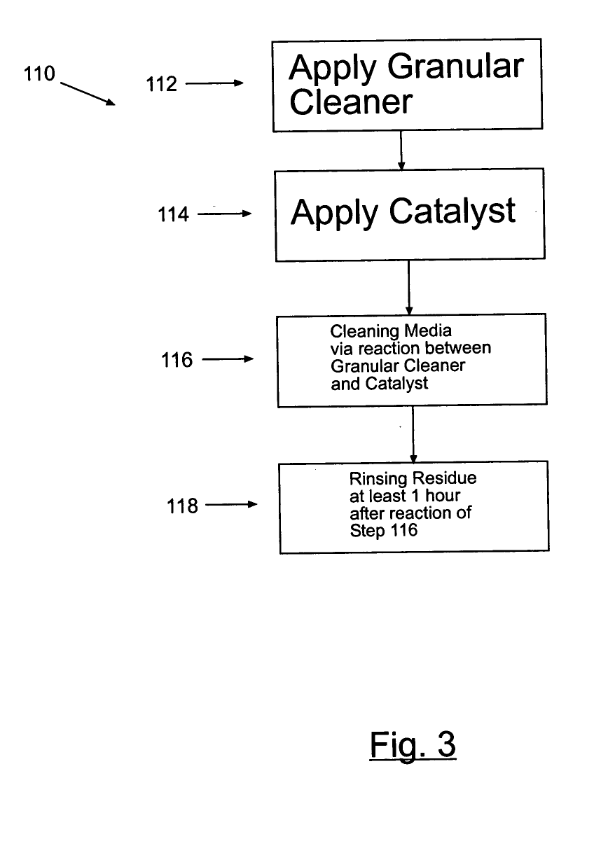

As shown in FIG. 3, an additional embodiment 110 of the present invention shows the chemical reaction between the granular cleaner and catalyst proceeding for at least 1 hour prior washing away of the residue granular clean and suspended and dissolved contamination.

An additional embodiment 120 includes using a pump to apply the granular cleaner to the top of the filter bed in the form of a slurry, which is being prepared by mixing the granular cleaner and water.

While the invention has been described with a certain degree of particularity, it is understood that the invention is not limited to the embodiments set forth herein for purposes of exemplification, but is to be limited only by the scope of the attached claims or including the full range of equivalency to which each element thereof is entitled.

What is claimed is:

1. In a filtration bed having water filtration media contained therein, a process to clean said water filtration media comprising the steps of:
applying a granular cleaner to said water filtration media; and
applying a catalyst to said water filtration media causing a chemical reaction between said granular cleaner, said catalyst and said water filtration media resulting in the cleaning of said water filtration media; and
applying water to rinse residue granular cleaner and catalyst along with suspended and dissolved contamination from the water filtration media.

2. The process to clean said water filtration media of claim 1 wherein said catalyst is a liquid.

3. The process to clean said water filtration media of claim 1 wherein said catalyst is a powder.

4. The process to clean said water filtration media of claim 1 wherein the application of said water to rinse said residue granular cleaner and catalyst along with said suspended and dissolved contamination from the water filtration media with or without agitating the filter media is conducted through backwashing said filter bed.

5. The process to clean said water filtration media of claim 1 further comprising the step of allowing the chemical reaction to proceed for at least 1 hour prior to applying said water to rinse said residue granular cleaner and catalyst along with said suspended and dissolved contamination from the water filtration media with or without agitating the filter media.

6. In the process to clean said water filtration media of claim 1 said granular cleaner is selected from the group consisting of and having a volume in the range of the following:
50-99% sulfamic acid;
0-10% citric acid;
0-10% phosphoric acid;
0-10% corrosion inhibitor;
0-10% free-flow additive;
0-10% surfactant; and
sodium bicarbonate as the balance.

7. In the process to clean said water filtration media of claim 1 wherein said phosphoric acid of said granular cleaner is replaced with hydrochloric acid in the same range of volume.

8. In the process to clean said water filtration media of claim 1 said catalyst is selected from a solution comprising:
a first component selected from the group consisting of and having a volume in the range of the following: 5-75% hydrogen peroxide, or 0.2-10% peracetic acid; and
a second component being water, said water accounting for the balance of volume.
